(19) United States
(12) Patent Application Publication
(10) Pub. No.: US 2026/0264627 A1
(43) Pub. Date: Sep. 10, 2026

(54) GARNISH ATTACHMENT FOR A VEHICLE A-PILLAR

(71) Applicant: Honda Motor Co., Ltd., Tokyo (JP)

(72) Inventors: Timothy J. RUPP, Dublin, OH (US); Juan Antonio VELA GONZALEZ, Monterrey (MX); Douglas R. KALTENMARK, Powell, OH (US)

(21) Appl. No.: 19/071,987

(22) Filed: Mar. 6, 2025

(51) Int. Cl. B60R 13/04; B60R 13/02; B60J 10/70

(52) U.S. Cl. CPC B60R 13/04; B60R 13/025; B60J 10/70

(57) ABSTRACT

A vehicle includes a body including an A-pillar and a garnish configured to cover the A-pillar. The garnish includes a garnish body including an outer surface and an inner surface opposite the outer surface in a thickness direction of the garnish body. The garnish body has a clip housing with an opening, and the clip housing is extended inwardly in a vehicle height direction relative to the inner surface so as to define a space between the inner surface and the clip housing. A clip is received in the opening of the clip housing and is attached to the A-pillar. An attachment member is secured to the body for mounting a support bracket. The support bracket engages the inner surface of the garnish body.

### BACKGROUND

It is known to attach a garnish to a vehicle body, for example an A-pillar, where an outer surface of the garnish defines part of an exterior surface of a vehicle. Typically, clips are provided for attaching the garnish, and an inner surface of the garnish includes a slotted enclosure or doghouse for receiving the clip. A regular clip packaging that includes such a doghouse requires a minimum of approximately 24.8mm from the outer surface of the garnish to a distal end or tip of the clip. While this arrangement is acceptable for certain vehicle models, the clip packaging must be reduced to meet crash and visibility requirements for battery electric vehicles (BEVs). With the crash and visibility requirements for BEVs, it is complicated to package the clips for attaching the garnish using traditional arrangements.

### BRIEF DESCRIPTION

According to one aspect, a vehicle comprises a body including an A-pillar and a garnish configured to cover the A-pillar. The garnish includes a garnish body including an outer surface and an inner surface opposite the outer surface in a thickness direction of the garnish body. The garnish body has a clip housing with an opening, and the clip housing is extended inwardly in a vehicle height direction relative to the inner surface so as to define a space between the inner surface and the clip housing. A clip is received in the opening of the clip housing and is attached to the A-pillar. An attachment member is secured to the body for mounting a support bracket. The support bracket engages the inner surface of the garnish body.

According to another aspect, a vehicle comprises a body including an A-pillar, a windshield having an exterior surface and a lateral edge secured to the body, and a garnish secured to the A-pillar and covering the A-pillar. The garnish includes a garnish body having an outer surface forming part of a vehicle exterior surface, an inner surface opposite the outer surface in a thickness direction of the garnish body, and a peripheral edge portion. A seal is secured to the inner surface and is extended at least partially along the peripheral edge portion. The garnish is attached to the A-pillar via a first attachment and a second attachment having a configuration different than the first attachment.

According to another aspect, a method of assembling a garnish to an A-pillar of a vehicle body is disclosed. The method comprises securing an attachment member to the A-pillar; connecting a support bracket to the attachment member; positioning a clip in a clip housing provided on an inner surface of the garnish; and attaching the clip to the A-pillar and attaching the support bracket to the inner surface of the garnish.

### BRIEF DESCRIPTION OF THE DRAWINGS

FIG. 1 is a schematic of a known vehicle including a garnish covering an A-pillar of a vehicle body.

FIG. 2 is a cross-sectional view taken along line 2-2 of FIG. 1.

FIG. 3 is a schematic of a battery electric vehicle including an exemplary garnish covering an A-pillar of a vehicle body.

FIG. 4 is a cross-sectional view taken along line 4-4 of FIG. 3.

FIG. 5 is a cross-sectional view taken along line 5-5 of FIG. 3.

FIG. 6 is a cross-sectional view taken along line 6-6 of FIG. 3.

FIG. 7 is a schematic view of the A-pillar of FIG. 3 showing mounting locations for clip and attachment members.

FIG. 8 is a perspective view of the attachment member and support bracket to be secured by the attachment member.

### DETAILED DESCRIPTION

It should, of course, be understood that the description and drawings herein are merely illustrative and that various modifications and changes can be made in the structures disclosed without departing from the present disclosure. Spatially relative terms may be used to describe an element and/or feature's relationship to another element(s) and/or feature(s) as, for example, illustrated in the figures. Further, any term of degree used herein, such as "substantially", means a reasonable amount of deviation of the modified word is contemplated such that the end result is not significantly changed. For example, such terms can be construed as allowing a deviation of at least 5% of the modified word if this deviation would not negate the meaning of the word the term of degree modifies.

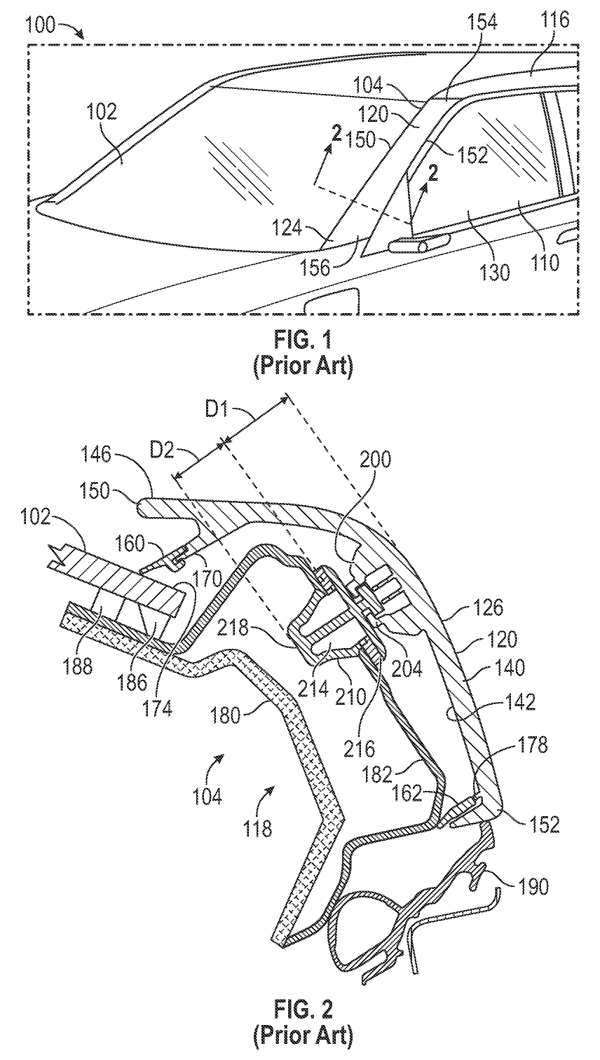

Referring now to the drawings, wherein like numerals refer to like parts throughout the several views, FIGS. 1 and 2 depict a vehicle 100 including a front windshield 102, an A-pillar 104, a driver’s side window 110, and a right roof rail 116. As is known in the art, the A-pillar 104 and the roof rail 116 define part of a vehicle frame or body 118. A garnish 120 covers the A-pillar 104. The A-pillar 104 is interposed between and separates the windshield 102 from the side window 110 in a lateral (i.e., width) direction of the vehicle 100, specifically in a left-right direction of the vehicle 100, such that an exterior surface of the vehicle 100 includes an exterior surface 124 of the windshield 102, an exterior surface of the A-pillar 104 (defined, for example, by an outer surface 126 of the garnish 120), and an exterior surface 130 of the side window 110 along the lateral direction of the vehicle 100.

FIG. 2 depicts a known construction of the garnish 120. The garnish 120 includes a garnish body 140 having the outer surface 126 forming part of the vehicle exterior surface, an inner surface 142 opposite the outer surface 126 in a thickness direction of the garnish body 140, and a peripheral edge portion 146. The peripheral edge portion 146 includes a first side edge portion 150, a second side edge portion 152 opposite the first side edge portion 150 along a first (i.e., width) direction of the garnish body 140, a first end edge portion 154, and a second end edge portion 156 opposite the first end edge portion along a second (i.e., length) direction of the garnish body 140 transverse to the first direction. The first side edge portion 150 is located closer to the windshield 102 as compared to the side window 110, and the second side edge portion 152 is located closer to the side window 110 as compared to the windshield 102. The first end edge portion 154 is located closer to the roof rail 116 as compared to the second end edge portion 156.

The garnish 120 in FIG. 2 includes a first seal 160 extended along the first side edge portion 150 and a second seal 162 extended along the second side edge portion 152. It should be appreciated that a third seal is extended along the first end edge portion 154 and a fourth seal is extended along the second end edge portion 156. The first seal 160 and the second seal 162 are separate and distinct extruded parts of the garnish 120 with different cross-sectional profiles. The first seal 160 is connected to a first mounting portion 170 on the inner surface 142 of the garnish 120 and is adapted to sealingly engaging a lateral side edge 174 of the windshield 102. The second seal 162 is connected to a second mounting portion 178 on the inner surface 142 of the garnish 120 and is adapted to sealingly engaging the vehicle body 118. Further depicted in FIG. 2 is the A-pillar 104 including a frame member 180 and a side panel outer 182. A windshield seal 186 is engaged to the vehicle body 118 and is located laterally of an adhesive 188, which adheres the windshield to the side panel outer 182. A door weatherstrip 190 is in contact with the vehicle body 118 and the garnish 120.

To attach the known garnish 120 to the A-pillar 104, a plurality of slotted enclosures or doghouses 200 are provided on the inner surface 142 of the garnish 120. Each doghouse 200 extends from the inner surface 142 and is spaced from the side panel outer 182 to define a certain distance D1 from the outer surface 126 of the garnish to the side panel outer 182. A space 202 is defined between a bottom 204 of the doghouse 200 and the side panel outer 182. A clip 210 is secured to the bottom 204 of each doghouse 200 and is received in an opening 214 in the side panel outer 182 of the A-pillar 104. A seal 216 is provided between the clip and the side panel outer. The clip 210 extends a certain distance D2 inside the side panel outer 182. As indicated, a regular clip packaging that includes such a doghouse 200 and clip 210 requires a minimum of approximately 24.8mm from the outer surface 126 of the garnish 120 to a distal end or tip 218 of the clip 210. While this arrangement is acceptable for certain vehicle models, the clip packaging must be reduced in size to meet crash and visibility requirements for battery electric vehicles (BEVs).

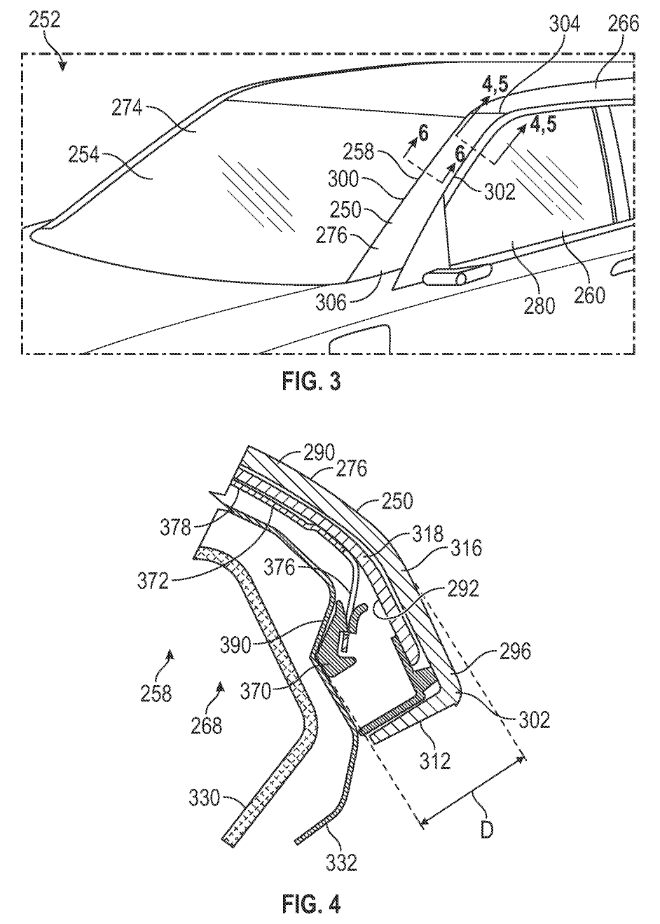

FIGS. 3-6 depict an arrangement of a garnish 250 according to the present disclosure for use with a BEV 252. Similar to the vehicle 100, the BEV 252 includes a front windshield 254, an A-pillar 258, a driver’s side window 260, and a right roof rail 266. The A-pillar 258 and the roof rail 266 define part of a vehicle frame or body 268. The garnish 250 covers the A-pillar 258. The A-pillar 258 is interposed between and separates the windshield 254 from the side window 260 in a lateral (i.e., width) direction of the vehicle 252, specifically in a left-right direction of the vehicle 252, such that an exterior surface of the vehicle 252 includes an exterior surface 274 of the windshield 254, an exterior surface of the A-pillar 258 (defined, for example, by an outer surface 276 of the garnish 250), and an exterior surface 280 of the side window 260 along the lateral direction of the vehicle 252.

Similar to the garnish 120, the garnish 250 includes a body 290 having the outer surface 276 forming part of the vehicle exterior surface, an inner surface 292 opposite the outer surface 276 in a thickness direction of the garnish body 290, and a peripheral edge portion 296. The peripheral edge portion 296 includes a first side edge portion 300, a second side edge portion 302 opposite the first side edge portion 300 along a first (i.e., width) direction of the garnish body 290, a first end edge portion 304, and a second end edge portion 306 opposite the first end edge portion along a second (i.e., length) direction of the garnish body 290 transverse to the first direction. The first side edge portion 300 is located closer to the windshield 254 as compared to the side window 260, and the second side edge portion 302 is located closer to the side window 260 as compared to the windshield 254. The first end edge portion 304 is located closer to the roof rail 266 as compared to the second end edge portion 306.

The garnish 250 in FIGS. 4-6 includes a first seal 310 extended along the first side edge portion 300 and a second seal 312 extended along the second side edge portion 302. It should be appreciated that a third seal is extended along the first end edge portion 304 and a fourth seal is extended along the second end edge portion 306. The first seal 310 and the second seal 312 can be part of a one-piece, unitary seal arrangement extended along the peripheral edge portion 296 of the garnish body, where the first seal and the second seal have different cross-sectional profiles along the peripheral edge portion 296. This allows the first seal 310 and second seal 312 to be tuned along the peripheral edge portion 296 without the need for differing mounting portions on the inner surface 292 of the garnish 250. In FIG. 4-6, the garnish 250 includes an outer body 316 and an inner body 318 secured to an underside of the outer member. The first seal 310 is adhered directed to the inner body 318 and is adapted to sealingly engaging a lateral side edge 320 of the windshield 274. The second seal 312 is adhered directed to the inner body 318 and is adapted to sealingly engaging the vehicle body 268. Further depicted is the A-pillar 258 including a frame member 330 and a side panel outer 332. A windshield seal 336 is engaged to the vehicle body 268 laterally outward of an adhesive 338 that adheres the windshield to the side panel outer 332.

To secure the garnish 250 to the A-pillar 258, the garnish body 290 has clip housings 350, each provided with an opening 352 configured to receive a clip 354 (see FIG. 6). Specifically, each clip housing 350 is extended inwardly in a vehicle height direction relative to the inner surface 292. In the depicted aspect, the inner body 318 includes the clip housing 350, and the clip housing is extended inwardly relative to the outer body 316 so as to define a space 358 between an underside of the outer body 316 and inner body 318. The clip 354 is received in the opening 352 of the clip housing 350 and attached to the A-pillar 258, specifically, the clip 354 is received in an opening in the side panel outer 332 of the A-pillar 258. A seal 364 is provided between the clip 354 and the side panel outer 332.

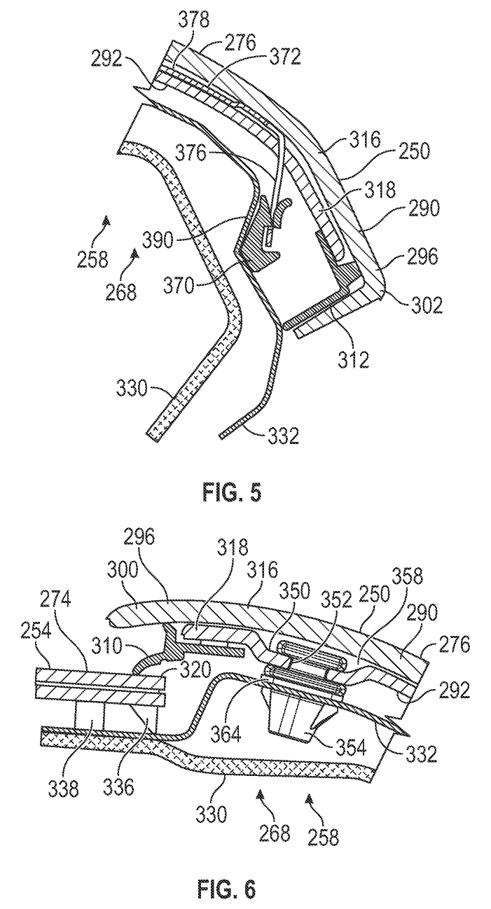

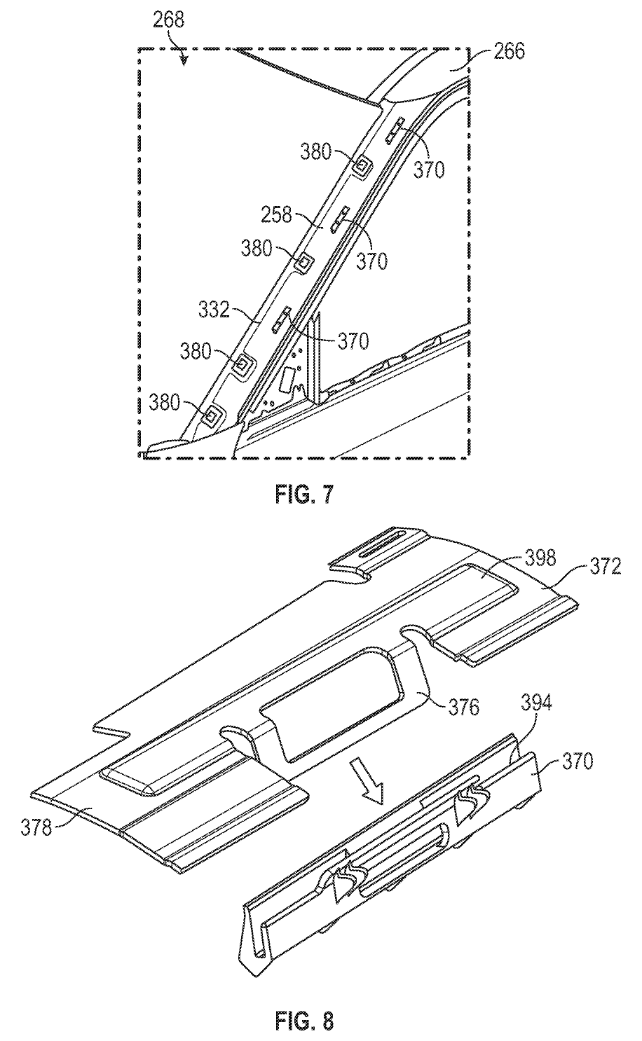

To further secure the garnish 250 to the side panel outer 332 of the A-pillar 258, an attachment member 370 is secured to the vehicle body 268 for mounting a support bracket 372 (see FIGS. 4 and 5). The support bracket 372 engages the inner surface 292 of the garnish body 290. The support bracket 372 includes a first section 376 and a second section 378 extended transverse to the first section in the vehicle width direction. The first section 376 is connected to the attachment member 370 and the second section 378 is attached to the inner surface of the garnish body. According to the aspect of FIG. 4, the second section 378 is attached to the inner body 318 of the garnish 250. According to the aspect of FIG. 5, the second section 378 is positioned between the outer body 316 and the inner body 318, and can be attached to the outer body 316 of the garnish 250. As shown in FIG. 7, the side panel outer 332 includes mounting locations 380 for the clips 354, and the clips 354 are attached to the A-pillar 258 at a first sealing surface (as defined by the first seal 310 along the first side edge portion 300 of the garnish body). Further depicted in FIG. 7, the attachment members 370 are secured to the A-pillar 258 at a second sealing surface (as defined by the second seal 312 along the second side edge portion 302 of the garnish body).

To reduce a clip packaging for the garnish 250, the attachment member 370 is secured to the side panel outer 318 at a stepped location 390 on the side panel outer 332. As shown in FIG. 8, the attachment member 370 includes a slot 394 that securely receives the first section 376 of the support bracket 372. Once positioned within the slot 394, an adhesive can be used to secure the first section 376. The second section 378 of the support bracket 372 can include a substantially planar area 398 that engages the inner surface 292 of the garnish body 290. It should be appreciated that the planar area 398 can be adhered to the inner surface 292, specifically the inner body 318 in FIG. 4 or the outer body 316 in FIG. 5. Therefore, by having a unique combination of the clips 354, the attachment members 370, and the support brackets 372, a distance D (FIG. 4) of the clip packaging from the outer surface 276 of the garnish 250 to the side panel outer 318 can be reduced to 21mm or less, depending on an installation angle of the garnish 250. Accordingly, the A-Pillar-garnish packaging is very tight, and it has a high impact on customer visibility and styling.

A method of assembling the garnish 250 to the A-pillar 258 of the vehicle body 268 is disclosed. The exemplary method comprises securing the attachment member 370 to the A-pillar; connecting the support bracket 372 to the attachment member 370; positioning the clip 354 in the clip housing 350 provided on the inner surface 292 of the garnish 250; and attaching the clip 354 to the A-pillar and attaching the support bracket 372 to the inner surface 292 of the garnish. As indicated, the garnish 250 includes the outer body 316 and the inner body 318 secured to an underside of the outer body, and the inner body includes the clip housing 350. The exemplary method includes attaching the support bracket 372 to the inner body 318. Alternatively, the exemplary method includes positioning the support bracket 372 between the outer body 316 and the inner body 318, and can include attaching the support bracket 372 to the outer body 316. The exemplary method can include nonremovably securing a seal to the inner surface 292 of the garnish 250 such that the seal is extended at least partially along the peripheral edge portion 296 of the garnish. The method can include attaching the clip 354 to the outer side panel 332 of the A-pillar 258 along a first sealing surface of the seal, and securing the attachment member 370 to the outer side panel 332 along a second sealing surface of the seal that has a cross-section profile different than the first sealing surface.

It will be appreciated that various of the above-disclosed and other features and functions, or alternatives or varieties thereof, may be desirably combined into many other different systems or applications. Also that various presently unforeseen or unanticipated alternatives, modifications, variations or improvements therein may be subsequently made by those skilled in the art which are also intended to be encompassed by the following claims.

1. A vehicle comprising:
a body including an A-pillar;
a garnish configured to cover the A-pillar, the garnish including a garnish body including an outer surface and an inner surface opposite the outer surface in a thickness direction of the garnish body, the garnish body having an clip housing with an opening, the clip housing is extended inwardly in a vehicle height direction relative to the inner surface so as to define a space between the inner surface and the clip housing;
a clip received in the opening of the clip housing and attached to the A-pillar; and
an attachment member secured to the body for mounting a support bracket, the support bracket engaging the inner surface of the garnish body.

2. The vehicle of claim 1, wherein the garnish body includes an outer body and an inner body secured to an underside of the outer body, wherein the inner body includes the clip housing.

3. The vehicle of claim 2, wherein the clip housing is extended inwardly relative to the outer body so as to define a space between an underside of the outer body and inner body.

4. The vehicle of claim 2, wherein the inner body includes the opening for the clip.

5. The vehicle of claim 2, wherein the support bracket includes a first section and a second section extended transverse to the first section, the first section connected to the attachment member and the second section attached to the inner surface of the garnish body.

6. The vehicle of claim 5, wherein the second section is attached to the outer body.

7. The vehicle of claim 5, wherein the second section is attached to the inner body.

8. The vehicle of claim 5, wherein the second section is positioned between the outer body and the inner body.

9. The vehicle of claim 5, wherein the second section is extended in a vehicle width direction.

10. The vehicle of claim 1, wherein the A-pillar is defined by a frame member and an outer side panel secured to the frame member, the clip and the attachment member secured to the outer side panel.

11. A vehicle comprising:
a body including an A-pillar;
a windshield having an exterior surface and a lateral edge secured to the body;
a garnish secured to the A-pillar and covering the A-pillar, wherein the garnish includes a garnish body having an outer surface forming part of a vehicle exterior surface, an inner surface opposite the outer surface in a thickness direction of the garnish body, and a peripheral edge portion; and
a seal secured to the inner surface and extended at least partially along the peripheral edge portion,
wherein the garnish is attached to the A-pillar via a first attachment and a second attachment having a configuration different than the first attachment.

12. The vehicle of claim 11, wherein the first attachment includes a clip housing on the inner surface of the garnish body and a clip received in an opening of the clip housing, the clip attached to the A-pillar.

13. The vehicle of claim 12, wherein the clip housing is extended inwardly relative to the inner surface so as to define a space between the inner surface and the clip housing.

14. The vehicle of claim 12, wherein the second attachment includes an attachment member secured to the A-pillar and a support bracket connected to the attachment member, the support bracket attached to the garnish body.

15. The vehicle of claim 14, wherein the garnish body includes an outer body and an inner body secured to an underside of the outer body, wherein the inner body includes the clip housing.

16. The vehicle of claim 15, wherein the support bracket is attached to one of the outer body and the inner body.

17. The vehicle of claim 15, wherein the support bracket is positioned between the outer body and the inner body.

18. A method of assembling a garnish to an A-pillar of a vehicle body, the method comprising:
securing an attachment member to the A-pillar;
connecting a support bracket to the attachment member;
positioning a clip in a clip housing provided on an inner surface of the garnish; and
attaching the clip to the A-pillar and attaching the support bracket to the inner surface of the garnish.

19. The method of claim 18, wherein the garnish includes an outer body and an inner body secured to an underside of the outer body, wherein the inner body includes the clip housing, and the method includes attaching the support bracket to one of the outer body and the inner body.

20. The method of claim 18, wherein the garnish includes an outer body and an inner body secured to an underside of the outer body, wherein the inner body includes the clip housing including, and the method includes positioning the support bracket between the outer body and the inner body.
